(19) United States
(12) Patent Application Publication
(10) Pub. No.: US 2021/0023733 A1
(43) Pub. Date: Jan. 28, 2021

(54) SAWMILL

(71) Applicants: CARL JAMES PETERSON, ROTORUA (NZ); KARL JACOB PETERSON, TAURANGA (NZ)

(72) Inventors: CARL JAMES PETERSON, ROTORUA (NZ); KARL JACOB PETERSON, TAURANGA (NZ)

(21) Appl. No.: 17/035,089

(22) Filed: Sep. 28, 2020

Related U.S. Application Data
(62) Division of application No. 12/674,674, filed on Apr. 8, 2014.

(51) Int. Cl. B27B 7/00; B27B 5/10; B23D 45/02

(52) U.S. Cl. CPC B27B 7/00; Y10T 83/8821; B23D 45/027; B27B 5/10

(57) ABSTRACT

Referring to FIG. 1), a sawmill has a pair of spaced end frames (1), (2), (4), a support beam (17) spanning the end frames and a saw carriage (56) moveable along the beam to carry a saw towards one end frame and then towards the other end frame. Each end frame has a ground engaging cross bar (1), a movable horizontal member (2) mounted on the cross bar (1) and an upright post (4). For each end frame the horizontal member (2) can run along the cross bar (1) to move the post (4) and consequently the beam (17) in adjustable increments towards one side of the sawmill and then towards the other side of the sawmill. The posts (4) support the beam (17) in a vertically adjustable elevated disposition.

### FIELD OF INVENTION

The present invention relates to the field of sawmilling.

### BACKGROUND

It is known to use portable sawmills to mill logs or large pieces of wood into a desired size and shape. With such sawmills simplicity of design and ease of transportation is desirable. It is accordingly an object of at least one form of the present way to go at least some way to achieving this or to at least provide the public with a useful choice.

The term “comprising” or derivatives thereof if and when used in this document should be interpreted non-exclusively. They should not be interpreted as excluding the option of additional unspecified parts.

### SUMMARY OF INVENTION

According to one aspect of the invention there is provided a sawmill having a first end frame, a second end frame, a support beam spanning the end frames, a saw carriage moveable along the beam to carry a saw towards one end frame and then towards the other end frame, each end frame having a ground engaging cross member, a movable base mounted on the cross member and an upright member; for each end frame the base being able to run along the cross member to move the upright member and consequently the beam in adjustable increments towards one side of the sawmill and then towards the other side of the sawmill; the upright members supporting the beam in a vertically adjustable elevated disposition.

Preferably the end frames are generally in the form of an inverted T.

Preferably one end of each ground engaging cross member has a wheel arrangement to facilitate lateral movement of the sawmill from one position to another.

Preferably the opposite end of each ground engaging cross member incorporates a ground contacting foot.

Preferably the support beam is generally in the form of a single beam.

Preferably the saw carriage is cantilevered sideways with respect to the support beam. Preferably the ground engaging cross members are foldable for ease of transport.

According to a further aspect of the invention there is provided a sawmill having a first end frame, a second end frame, a vertically adjustable support beam spanning the end frames, a saw carriage moveable along the beam to carry a saw towards one end frame and then towards the other end frame; each end frame having a cross member and a moveable base member both substantially above the beam, a downwards support member extending from the base member to the beam such that the beam is supported in an elevated disposition by the cross member as well as by the base member and the downwards support member, the base member being able to move along the cross member to carry the downwards support member and thus the beam towards one side of the sawmill and then towards the other side of the sawmill.

Preferably the downwards support member comprises a rigid bar or tube.

Preferably each cross member has an outrigger support post which can proceed substantially vertically from the cross member to ground level to support the cross member and can, via a pivot mechanism, swing upwards clear of ground level to facilitate movement of a log to a position underneath the beam.

### BRIEF DESCRIPTION OF DRAWINGS

Some preferred embodiments of the invention will now be described by way of example and with reference to the accompanying drawings, of which:

FIG. 1 is an isometric view of a portable sawmill assembled and ready for use;

FIG. 2 is an end view of the sawmill;

FIG. 3 is a side view of the sawmill;

FIG. 4 is an end view showing detail of a roller bearing arrangement forming part of the sawmill;

FIG. 5 shows detail of a winch mechanism forming part of the sawmill;

FIG. 6 is an isometric view of a sawmill according to a further embodiment of the invention;

FIG. 6a illustrates a cross bar folding mechanism applicable to various embodiments of the invention;

FIG. 7 is a side view of a saw carriage and saw blade forming part of the FIG. 1 sawmill;

FIG. 8 illustrates detail of a beam for the saw carriage;

FIG. 9 is an isometric view of the sawmill of FIG. 1 when in a more compact or more easily transportable state;

FIG. 10 is an isometric view of a sawmill and trailer according to a further embodiment of the invention;

FIG. 11 is an isometric view showing the sawmill of FIG. 1 when in use to cut a log;

FIG. 12 is an end view showing detail of the sawmill of FIG. 1;

FIG. 13 is a further end view showing detail of the sawmill of FIG. 1;

FIG. 14 is an isometric view of a long span sawmill according to a further embodiment of the invention;

FIG. 15 illustrates detail of a beam used for supporting a saw carriage in some embodiments of the invention;

FIG. 16 is an end view illustrating detail of a mechanism for facilitating sideways movement of sawmill parts;

FIG. 17 is an end view illustrating detail of a mechanism for facilitating vertical movement of sawmill parts;

FIG. 18 is an end view illustrating detail of a mechanism for facilitating sideways movement of sawmill parts;

FIG. 19 is an isometric view of a sawmill according to a further embodiment of the invention;

FIG. 20 is an isometric view of a sawmill according to a further embodiment of the invention;

FIG. 21 is an isometric view of a sawmill according to a further embodiment of the invention;

FIG. 22 is an isometric view of a sawmill according to a further embodiment of the invention;

FIG. 23 provides end and side views of the sawmill of FIG. 22;

FIG. 24 is an isometric view of a sawmill according to a further embodiment of the invention;

FIG. 25 provides end and side views of the sawmill of FIG. 24;

FIG. 26 is an end view detailing a preferred beam for supporting a saw carriage used by sawmills according to some embodiments of the invention; and

FIG. 27 illustrates detail of a blade swing mechanism suitable for use in sawmills according to some embodiments of the invention.

FIG. 28 is an isometric view of a sawmill according to a further embodiment of the invention;

### DETAILED DESCRIPTION

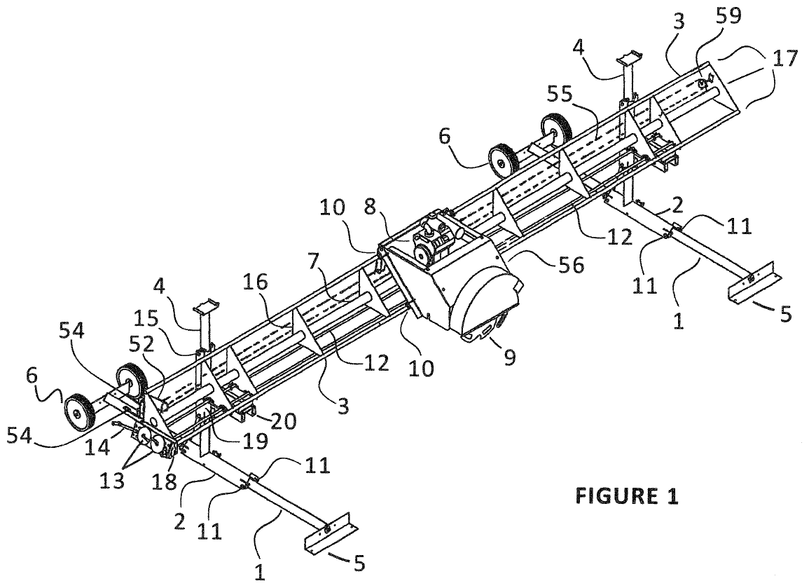

Referring to FIG. 1, there is shown a portable sawmill having a pair of spaced end frames, each end frame having a generally horizontal cross bar 1 at just above ground level. Each cross bar 1 incorporates a stability bar or foot 5 which makes contact with the ground at a first side of the mill. Each end frame also comprises an inverted T shaped support made up of a lower horizontal member 2 and an upright post 4. The horizontal member 2 engages the horizontal cross bar 1 by way of roller bearings 11 to enable it to be moved back and forth along that cross bar 1 in a smooth manner.

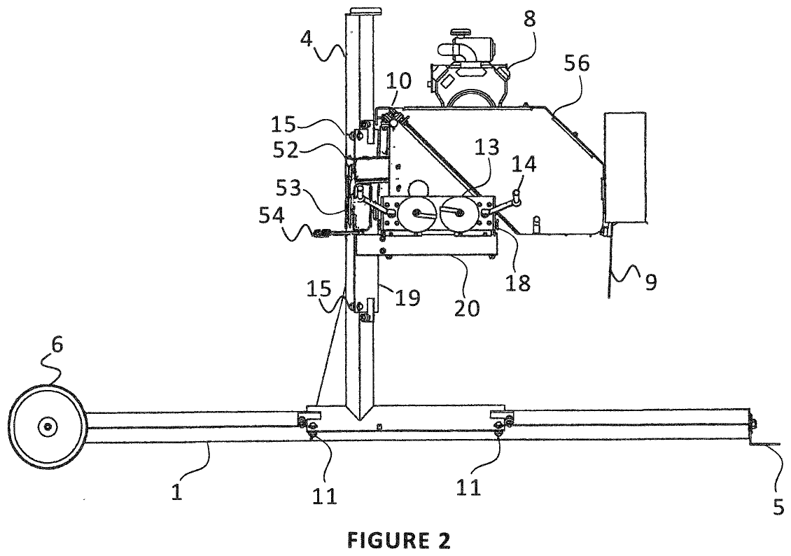

Referring to FIGS. 1 and 2, each upright post 4 is engaged by a vertical adjustment plate 19. The adjustment plates 19 can move up and down along their respective upright posts 4 by way of roller bearings 15. Each adjustment plate 19 supports an outwardly extending support arm 20. As shown, each support arms 20 is perpendicular with respect to its associated adjustment plate 19. The support arms 20 serve to support a main beam 17 which runs from one end frame to the other, and even extends beyond such end frames. More particularly, the main beam 17 rests on the support arms 20 above ground level.

As shown in FIG. 1, the main beam 17 comprises a tubular centre beam 7 surrounded by three smaller outer beams 3 set in a triangular configuration. These provide a type of truss effect to impart substantial structural integrity. The main beam 17 also has a series of generally triangular support plates 16 to hold the centre and outer beams 7, 3 rigid with respect to one another. Two of the outer beams 3 serve as rails or runners for a saw carriage 56. In this regard the saw carriage 56 engages two of the outer beams 3 and can run back and forth along these by way of roller bearings or wheels 10. The saw carriage 56 has a combustion engine 8 for driving the blade 9 of a circular saw (in alternative embodiments an electric motor may be used for this).

As shown in FIGS. 1, 2 and 3, each end frame has a pair of ground wheels 6 at the end of the horizontal cross bar 1 furthest from the corresponding foot 5. The wheels 6 enable one to easily and manually shift the sawmill sideways in relation to a log to be worked on.

As best shown in FIG. 1, a pair of manually operated winches 14 is mounted at one end of the main beam 17 to drive associated drive shafts 12. One of the drive shafts 12 transfers force from one of the winches 14 to cause side to side movement of the inverted T shaped supports and thus the main beam 17, the saw carriage 56 and the blade 9. The other drive shaft 12 transfers force from the other of the winches 14 to cause vertical adjustment of the main beam 17. The degree of movement is in each case indicated by a respective one of two sizing gauges 13 associated with the winches 14. As best seen in FIG. 2, the winches 14 are mounted on a pivoting control plate 18 which allows for easy reading of the gauges 13 at any of a number of vertical adjustments possible for the main beam 17.

With reference to FIGS. 1, 2 and 3, an electric motor 52 is mounted adjacent to the control plate 18 for providing power to move the saw carriage 56 back and forward along the main beam 17. The motor 52 is connected by way of a pulley and v-belt to a hydrostatic drive unit 53, which is in turn controlled through a lever 54. The hydrostatic drive unit 53, is connected to the saw carriage 56 by way of gear cogs and a looped chain 55 which runs around an idler pulley 59 at the end of the sawmill remote from motor 52.

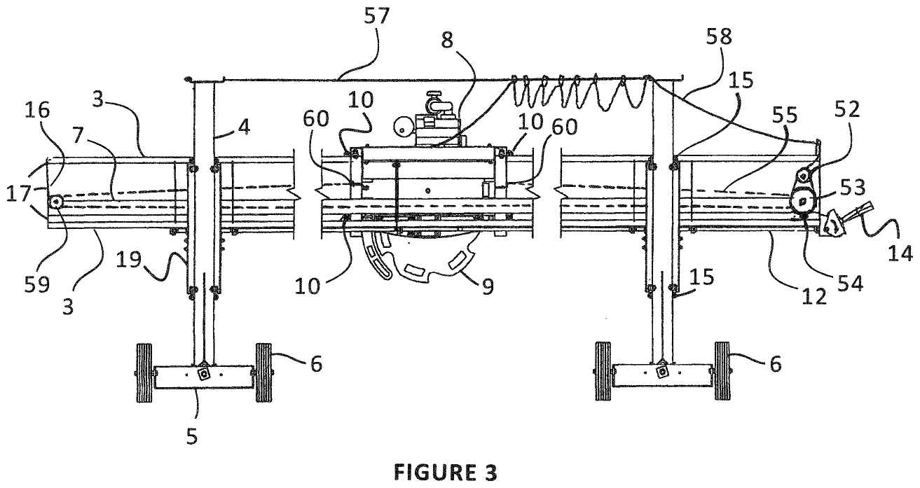

Referring to FIG. 3, electricity can be supplied from the saw engine 8 on the saw carriage 56 to the. electric motor 52 to power the hydrostatic drive unit 53 by way of a multi-cord electrical cable 58. The cable 58 passes through sliding rings which are spaced across and supported by a guy wire 57 running above the saw carriage 56 from one end frame to the other. The electrical cable 58 is also used to deliver electrical commands from a human operator position in front of the winches 14 to an electric changeover unit and a board removal device on the saw carriage. The changeover unit causes the blade to flip between vertical and horizontal orientations at appropriate times and the board removal device causes a cut board to be moved clear of the saw carriage.

In some embodiments of the invention the blade angle can be set between horizontal and vertical, for example to enable 45 degree cuts, etc.

When the sawmill is in use the inverted T shaped supports can be moved side to side as a result a human operator turning one of the winches 14 to align the blade 9 with a log beneath the main beam 17. The main beam 17 can be adjusted vertically by a human operator turning the other of the winches 14 to bring the blade into a correct vertical position for cutting the log. The saw carriage 56 is preferably moved along the main beam 17 mechanically but in at least some embodiments of the invention this can be done manually (ie by pushing and pulling on it). Those skilled in the art will appreciate that the saw carriage can be moved back and forward along the top part of a log in passes, the blade 9 being set vertically in one pass and then horizontally in the next, repeatedly, until a series of planks, or slabs, etc, are cut from the log. This is achieved by making sure that the vertical and horizontal cuts intersect, progressively adjusting the sideways position of the carriage after vertical and/or horizontal cuts, and progressively adjusting the vertical position of the saw carriage after a row of boards or slabs have been sawn from the log. As the blade 9 is set on a blade swing mechanism it can be readily flipped between horizontal and vertical to make correspondingly oriented cuts. Any suitable blade swing mechanism known in the art can be employed to enable this.

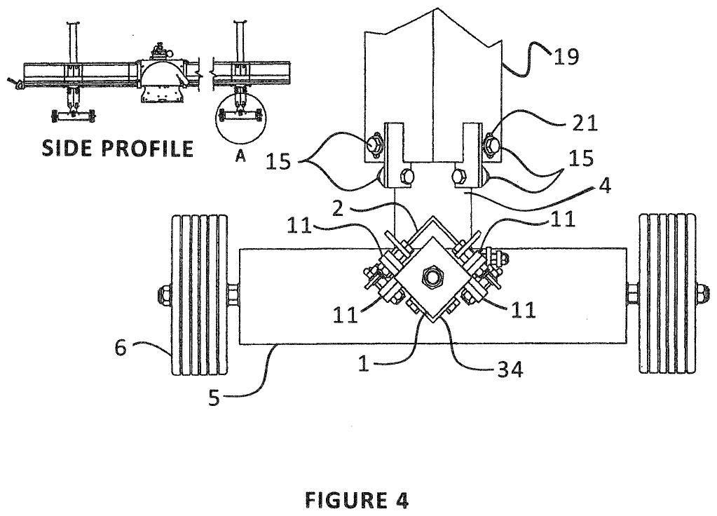

FIG. 4 shows detail of the roller bearings 11 described above for facilitating movement of each inverted T shaped support with respect to its corresponding end frame cross bar 1. Detail for each adjustment plate 19 is also shown, with double bearings 15 used to facilitate stability and vertical movement of such plate with respect to the associated upright post 4. An adjustment slot 21 is used to allow fine adjustments to the double bearings 15 to minimise vibration and facilitate rigidity. An angular locking bracket 34 can serve to lock a hinged portion of the end frame cross bar.

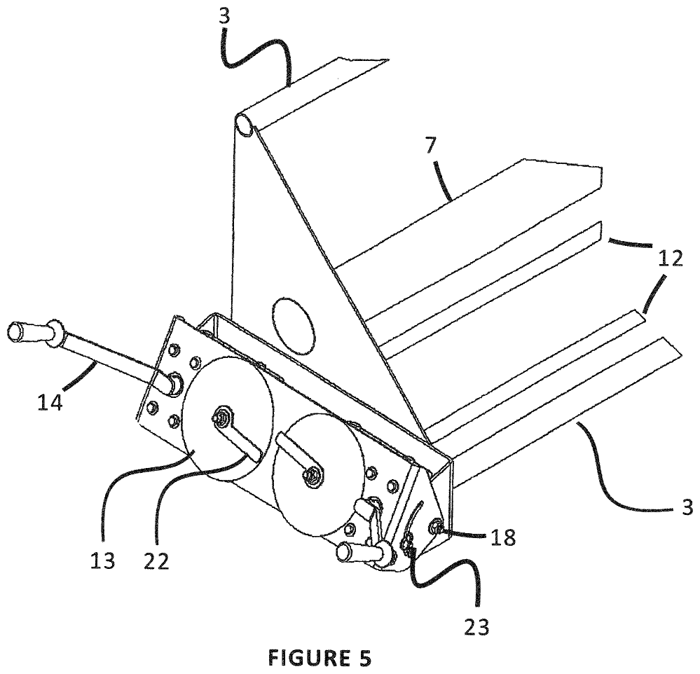

FIG. 5 provides further detail of the winches 14 and gauges 13, their sizing pointers 22 and wing nut for locking the angle of the control plate 18.

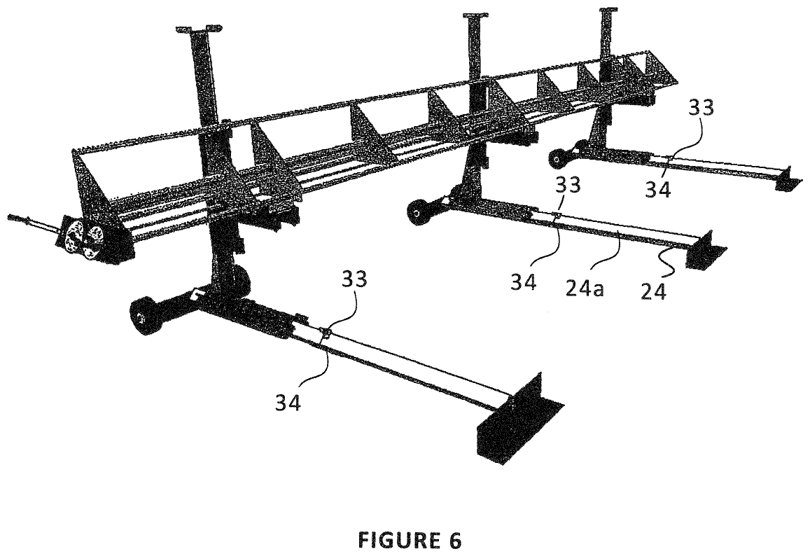

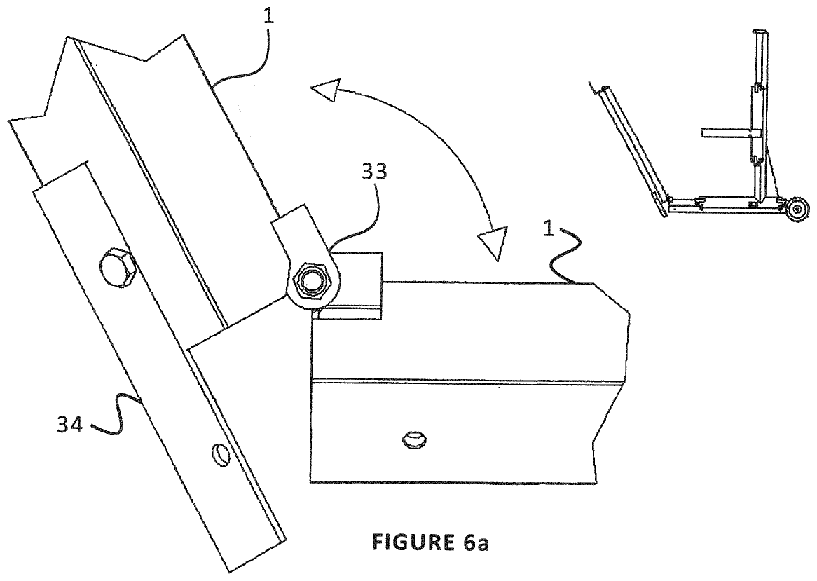

FIG. 6 illustrates a further embodiment of the main structure of a sawmill similar to that described above but having a mid frame 24. FIG. 6 also shows locking bolts 33 and indicates the position of the locking brackets 34 used to maintain the mid frame's horizontal bar 24 a in a rigid non-folded disposition. By loosening the bolts 33 and adjusting the brackets 34 the horizontal bar 34 can fold about a hinge mechanism to make the sawmill more compact for transportation. This is illustrated by FIG. 6 a and the same folding arrangement is applicable to the sawmill of FIG. 1.

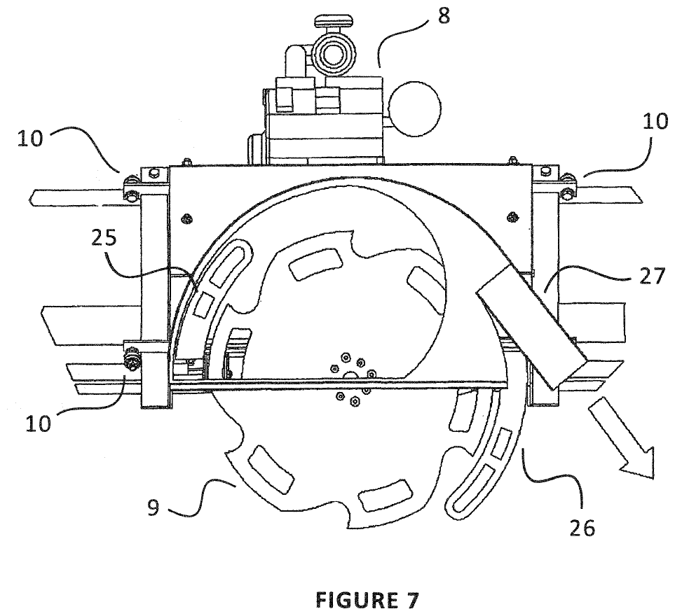

FIG. 7 shows detail of saw carriage 56 and blade 9, including the positioning of horizontal and vertical riving knives 25, 26 and a sawdust deflector 27.

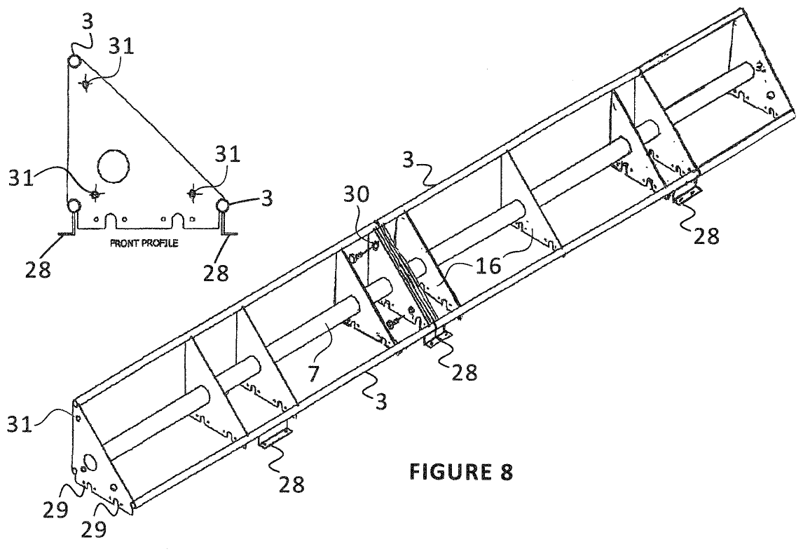

FIG. 8 shows detail of the main beam 17, including brackets 28 used to connect such beam to the support arms 20, etc.

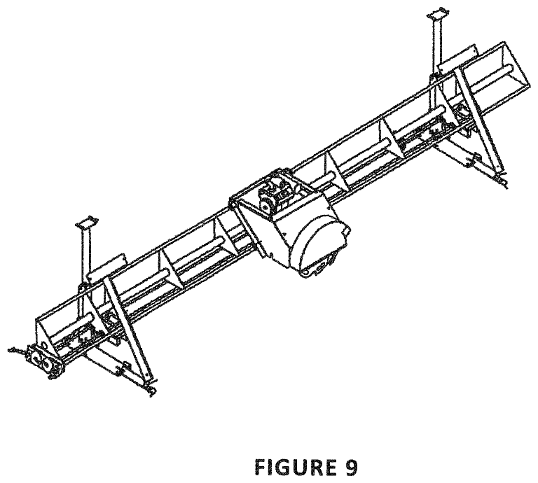

FIG. 9 shows the sawmill of FIG. 1 when the end frame horizontal bars 1 are folded up about hinges to facilitate transportation.

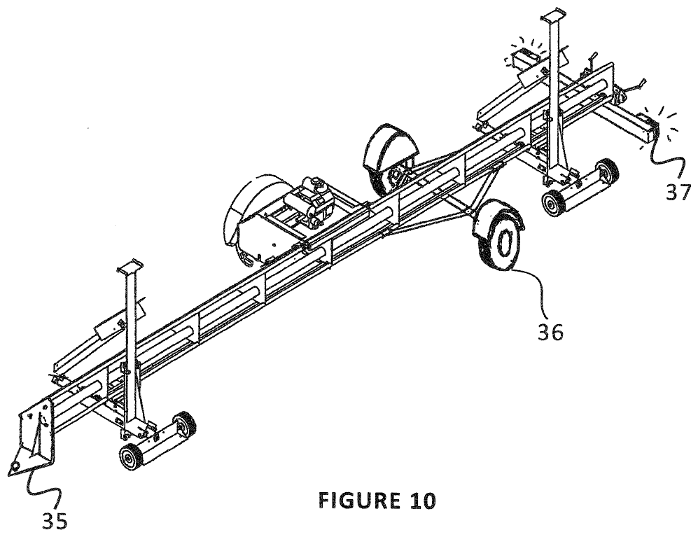

FIG. 10 illustrates an alternative embodiment of the invention, being a sawmill incorporating a detachable trailer unit to facilitate movement to a desired location. The mill has a tow ball mounting plate 35, a main axle unit with wheels 36 and a detachable rear lighting bar 37 for making road signals, for example when turning, reversing or stopping.

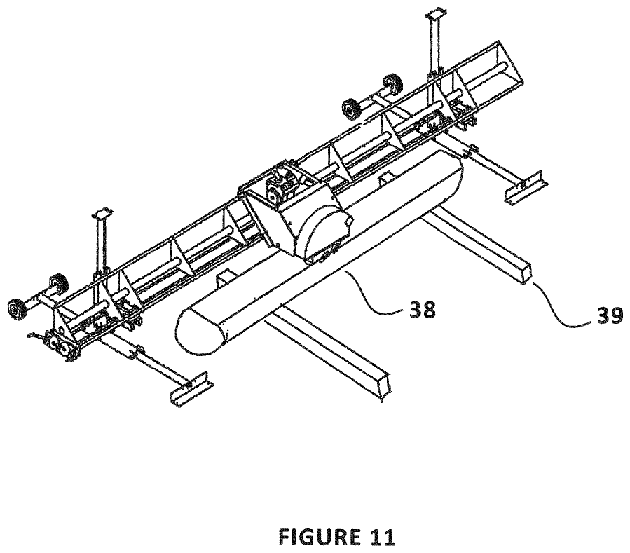

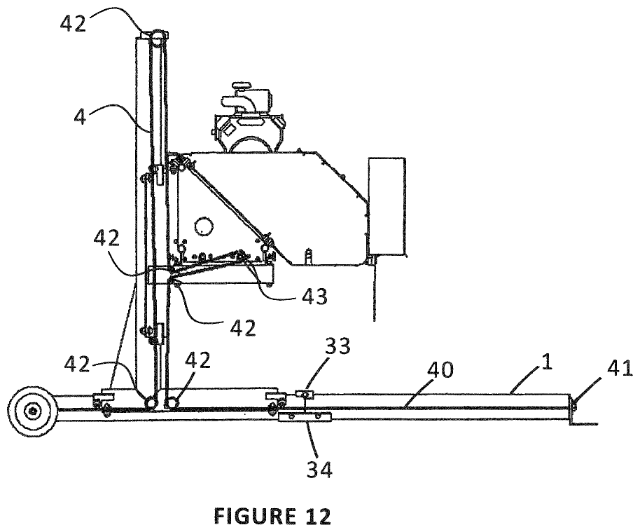

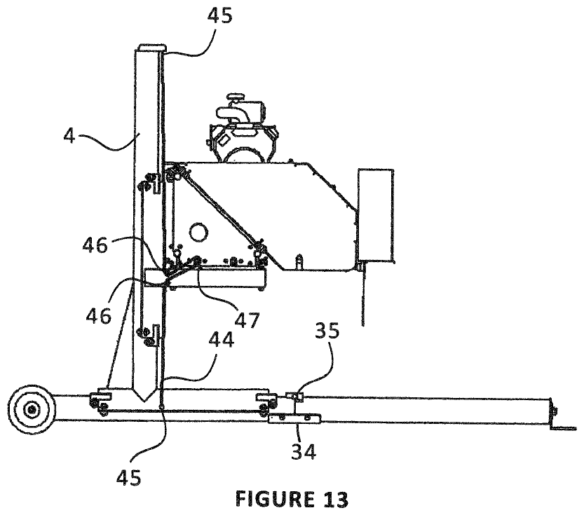

FIG. 11 illustrates a sawmill as per the FIG. 1 embodiment when in use cutting a log 38. As shown, the log 38 is held slightly above ground level by two blocks or rails 39. FIG. 12 illustrates a chain arrangement 40 applicable to the same sawmill for moving the inverted T shaped support from side to side. As shown, chain is connected to the end frame's cross bar 1 at point 41 near the associated foot 5. The chain extends to and passes around an idler pulley 41 at the opposite side of the cross bar 1, extends to and around further idler pulleys 42 so that it runs to the top of the upright post 4, then part way down, around a chain drive sprocket 43, and then to the bottom of the post 4. FIG. 12 also illustrates the locking bolt 33 and locking brackets 34 used to maintain the mid frame's cross bar 1 in a rigid non-folded disposition. These can be released to enable the cross bar 1 to fold up as discussed above for FIG. 9. FIG. 13 illustrates a further chain arrangement 44 used for the vertical adjustment of the main beam 17 and thus the saw carriage 56 and blade 9. As shown chain 44 is connected at point 45 near the base of the upright post 4, extends upwards around idler pulleys 46 and chain drive sprocket 47, and from there extends to and is fixed to the top part of the post 4.

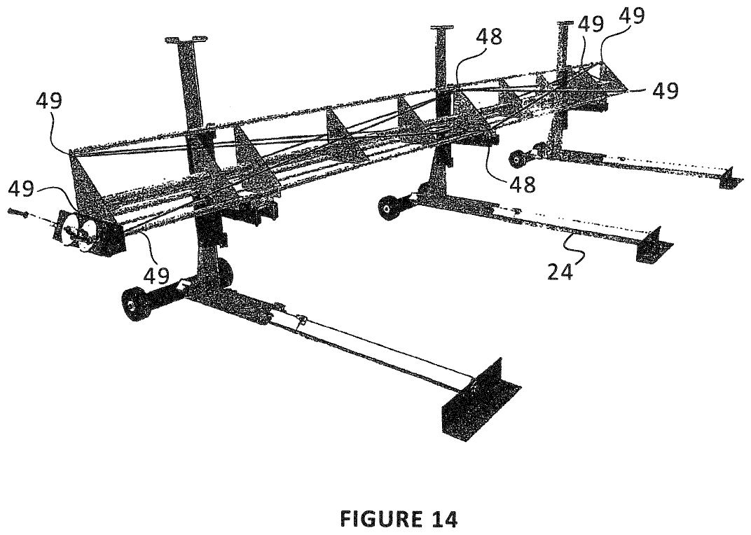

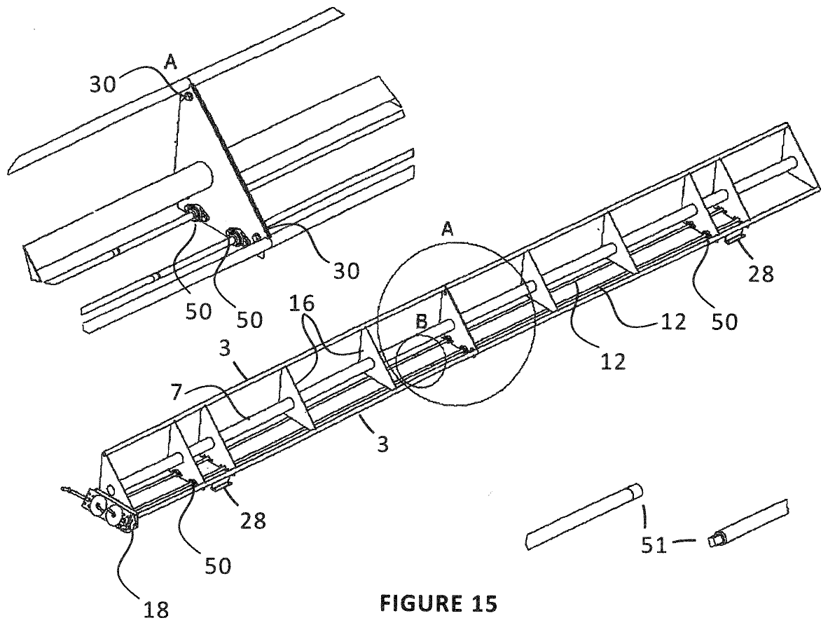

FIG. 14 illustrates a sawmill similar to that of FIG. 1, except that it has a mid frame 24, a particularly long main beam, and a cable arrangement for pre-stressing and strengthening such beam. This is achieved through four separate cables attached at points 48 and 49. FIG. 15 provides detail of the main beam including the drive shafts 12 and their support bearings 50. Item 51 illustrates the manner in which the drive shafts can be a built up from a number of shorter lengths.

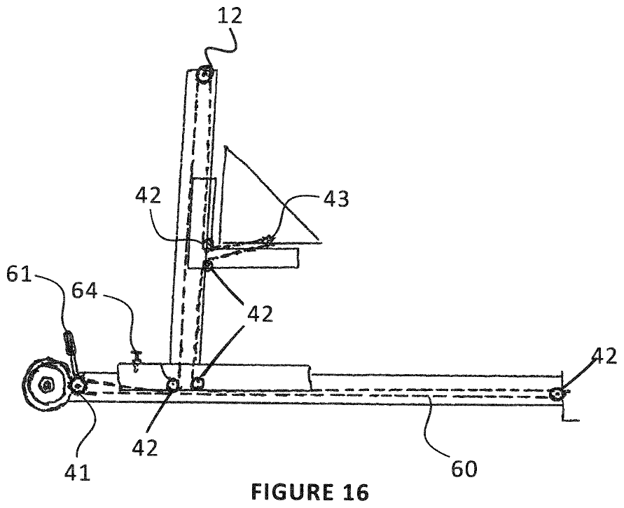

FIG. 16 illustrates a preferred mechanism for facilitating sideways movement of the inverted T shaped support of each end frame in at least some sawmills according to the invention. This involves a looped chain arrangement 60 having a locking arm 61 which can be set to a locked position to prevent the sideways movement and then unlocked.

As shown, there is a locking T bolt 64 which can tightened to prevent sideways movement of the near end inverted T shaped support while allowing for movement of the far end T shaped support.

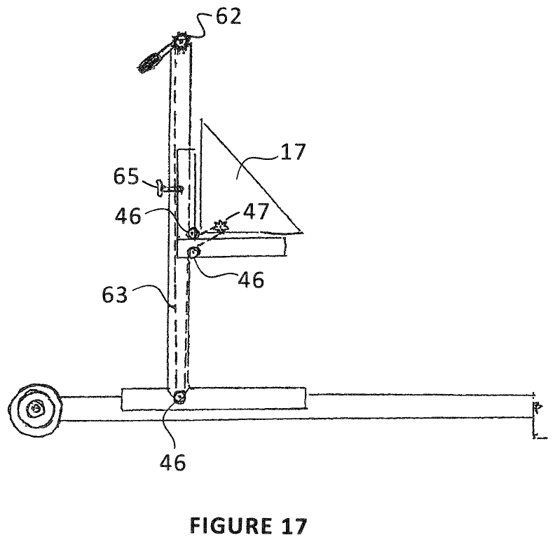

FIG. 17 illustrates a preferred mechanism for facilitating up and down movement of the main beam 17 in at least some sawmills according to the invention. This involves a looped chain arrangement 63 having a locking arm/pulley 62 which can be set to a locked position to prevent the up and down movement and then unlocked to allow it. As shown, there is a locking bolt 65 which can be tightened to prevent up and down movement of the near end inverted T shaped support while allowing for movement of the far end inverted T shaped support.

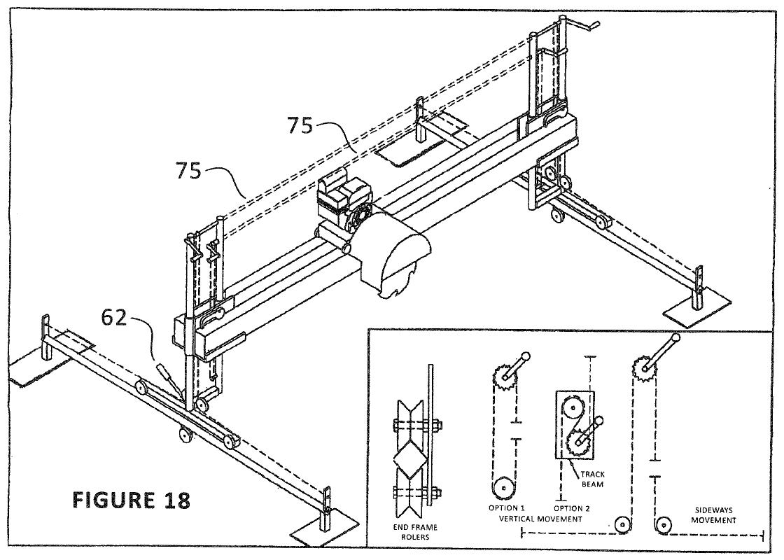

FIG. 18 illustrates a sawmill according to a further embodiment of the invention, similar in some resects to the FIG. 1 embodiment, but having two uprights posts 66 at each end frame and two beams 67 rather than just a main beam 17. The FIG. 18 embodiment can be particularly useful in situations requiring enhanced stability and support for the saw carriage. As shown, telescopically adjustable force transfer drive shafts 75 can be employed to accommodate adjustments to the overall length of the sawmill and thus longer or shorter logs.

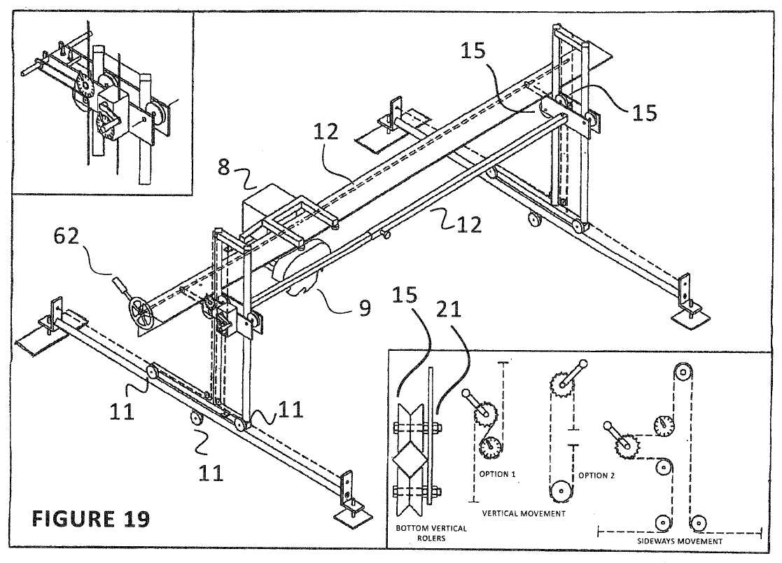

FIG. 19 illustrates a sawmill according to a further embodiment of the invention, wherein each end frame has two vertical posts 68 both disposed in the same plane as the cross bar 1. This sawmill has a main beam 69 which is a right angle shape in transverse cross section.

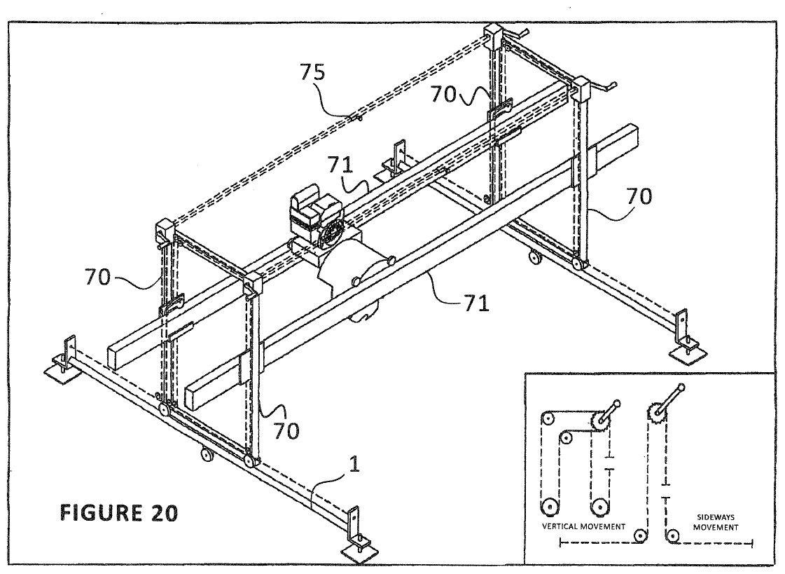

FIG. 20 illustrates a sawmill according to a further embodiment of the invention wherein each end frame also has two vertical posts 70 both disposed in the same plane as the cross bar 1. The vertical posts 70 support a pair of beams 71 along which a saw carriage can run to cut a log. In this embodiment the beams 71 are spaced quite significantly to enable a sawmill operator to walk between them while a cut is being made. The use of two beams 17 means that they can each be of lighter construction than if only one beam was used as per the FIG. 1 sawmill.

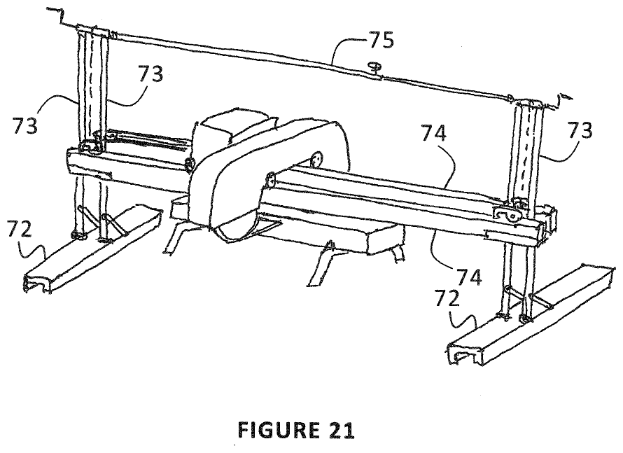

FIG. 21 illustrates a sawmill according to a further embodiment of the invention wherein each end frame has a foldable cross bar 72 supporting a pair of upright posts 73 (in some embodiments of this sawmill there may only be one upright post). A pair of horizontal beams 74 is clamped to the outwards facing sides of the posts upright 73 so that a saw carriage can roll along such beams. A telescopic drive shaft 75 facilitates transfer of force between the end frames to facilitate lifting and lowering of the two beams 74.

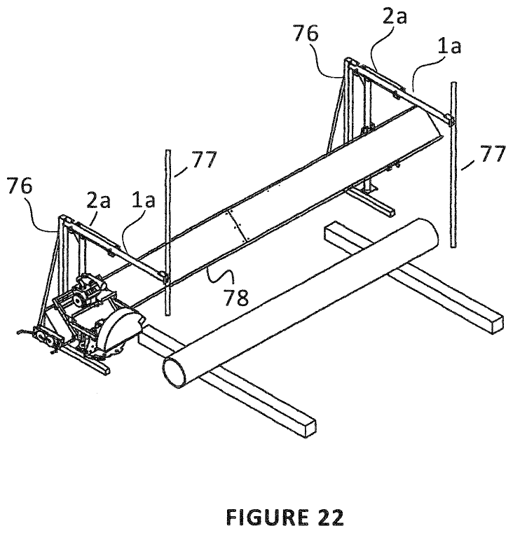

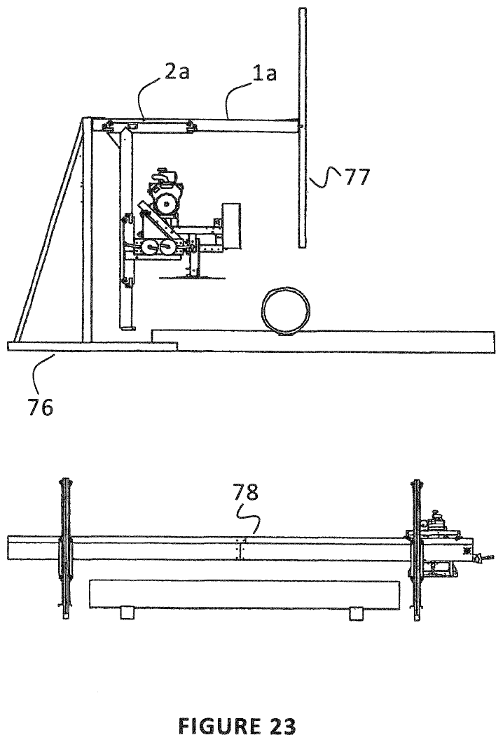

FIGS. 22 and 23 illustrate a sawmill according to a further embodiment of the invention wherein end frame cross bars 1a are in a substantially elevated or overhead disposition. Each end frame has a generally inverted L shaped sideways movement frame 2a, main framing 76, and a hinged outrigger type support post 77. In each case the L shaped sideways movement frame can roll along the corresponding cross bar 1a to move the main beam 78 and thus the saw carriage sideways. This is done with an adjustable winch mechanism the same of similar to that described previously. Vertical adjustment of the beam and thus the saw carriage is also possible by way of a winch mechanism the same or similar to that described previously. The outrigger support posts 77 can be swung up and down about the cross bars 2a to enable one to easily roll a long log under the mill to the vicinity of the saw carriage support beam 78.

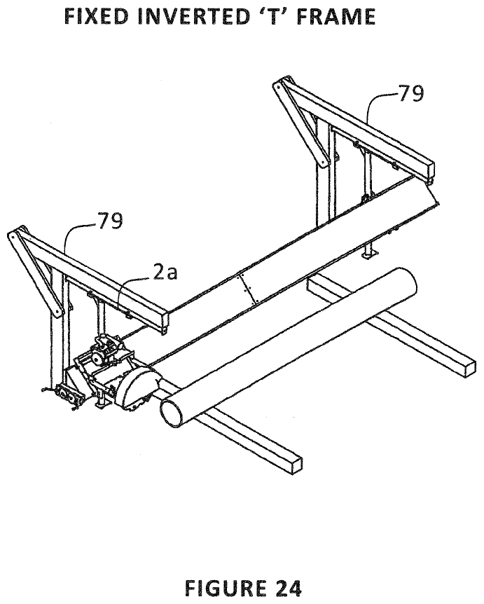

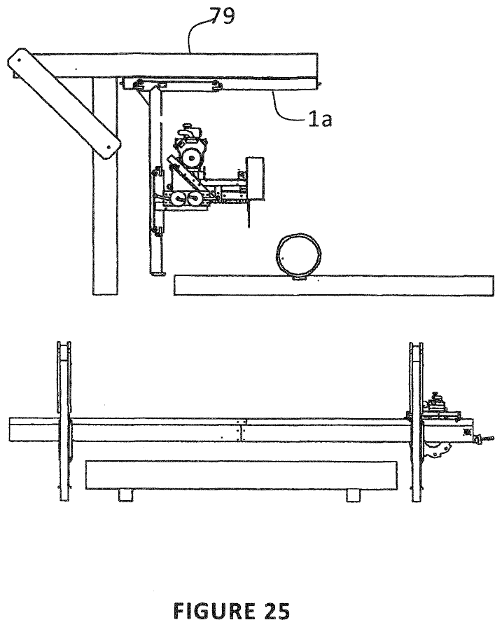

FIGS. 24 and 25 illustrate a sawmill similar to that of FIGS. 22 and 23 but having a particularly robust overhead beam 79 for supporting the inverted L shaped sideways moving frame 2a.

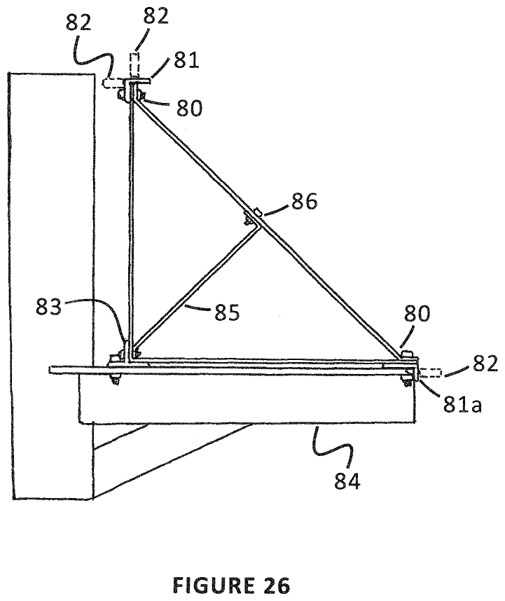

FIG. 26 illustrates end on detail of a preferred beam for use in sawmills according to the invention (eg as per the beam 17 discussed in relation to FIG. 1). As shown, 45° corners are facilitated by way of 135° folds 80. Hardened steel angles 81, 81a are bolted to the folds 80 to provide tracks for saw carriage wheels or roller bearings 82. A T angled section 83 provides for easy access bolt down onto a beam holder or support arm 84, as does the fold at 81a. A folded metal section 85 can be bolted or riveted at points 83 and 86 to facilitate strength and rigidity. The resulting inner truss structure extends only from end frame to end frame, allowing space at the beam ends for components necessary for effecting beam movement, eg chain drives, sprockets, drive motors, etc.

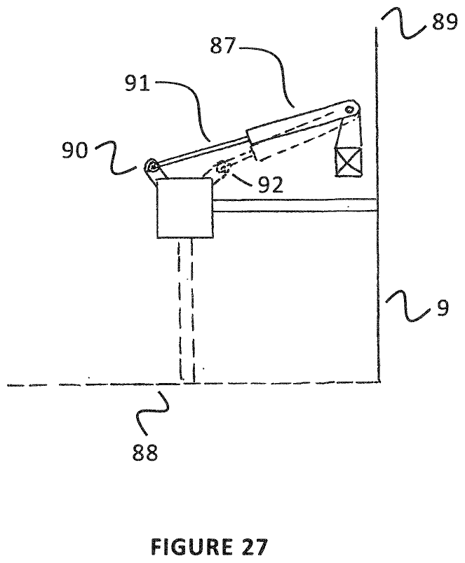

FIG. 27 illustrates a gas stilt 87 which can be used to swing the blade 9 employed in embodiments of this invention between horizontal and vertical orientations, ie for making horizontal and vertical cuts respectively. The blade is shown in hard lines 89 to indicate its vertical disposition and in broken lines 88 to illustrate its subsequent horizontal disposition. When the blade is in the vertical disposition 90 the gas strut is fully extended 91 and is at maximum leverage. In the horizontal disposition 92 the gas strut is compressed and in a near neutral leverage position.

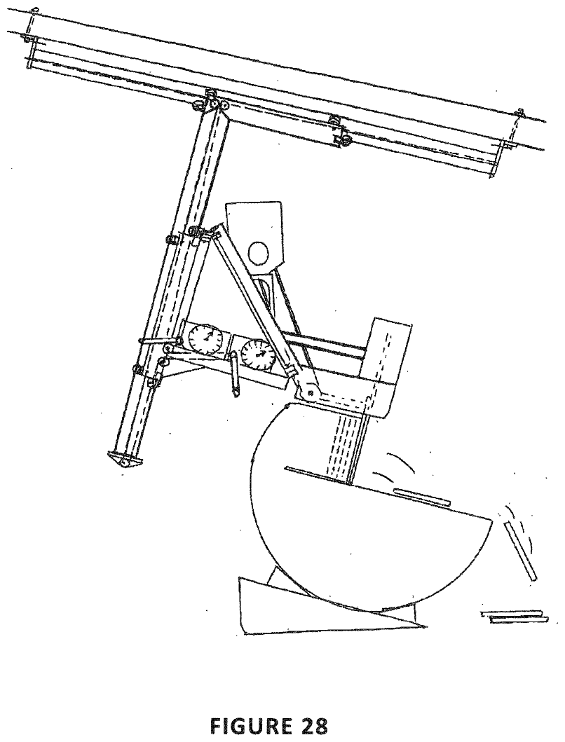

FIG. 28 illustrates a mill similar to that described with reference to FIG. 24, but with a facility to enable the robust overhead beam to tilt. With the log also in a tilted disposition, supported by blocks, boards cut from the log tend to fall away from the vicinity of the blade when they are cut free from the log. Embodiments of the mill corresponding to FIG. 1 can also be made with a tilting facility, ie so that the ground engaging parts are tilted (eg jacked, winched up, on one side more than the other, etc), to enable cut boards to be easily cleared from the vicinity of the blade.

While some preferred embodiments of the invention have been described by way of example it should be appreciated that modifications and improvements can occur without departing from the scope of the appended claims.

1-19 (canceled)

20. A sawmill having a pair of end frames, a horizontal beam held elevated by the end frames, a saw and a carriage arranged to move the saw back and forth along the beam;
the saw comprising a motor, a blade, a drive shaft connecting the motor and the blade, and a swing mechanism arranged to swing the blade from a vertical orientation suitable for making vertical cuts in a log and a horizontal orientation suitable for making horizontal cuts in the log; and
characterized in that when the blade is in the vertical orientation the drive shaft extends under the beam and the blade is at an opposite side of the beam to the motor.

21. A sawmill according to claim 21, wherein the swing mechanism is below an upper level of the horizontal beam.

22. A sawmill according to claim 21, wherein each end frame comprises a cross member at approximately ground level, a base mounted on the cross member and an upright member, such that the base runs along the cross member to move the upright member and consequently the horizontal beam in adjustable increments between one side of the sawmill and the other side of the sawmill.

23. A sawmill according to claim 21, wherein each end frame is in a form of an inverted T.

24. A sawmill according to claim 21, wherein the horizontal beam engages and moves along an upright post of each end frame by way of roller bearings, the roller face of each bearing having a wedge shaped female recess that rolls along a complimentary shaped external male edge of the upright post in a female-male relationship.

25. A sawmill according to claim 21, wherein the horizontal beam is the only beam along which the saw carriage moves back and forward between the end frames.

26. A sawmill according to claim 21, wherein the horizontal beam engages an upright post of each end frame, and when the blade is in its vertical orientation the blade is between each upright post and the horizontal beam.

27. A sawmill having a pair of end frames, a horizontal beam held elevated by the end frames, a saw comprising a motor and a blade, and a carriage arranged to move the saw back and forth along the beam;
a swing mechanism arranged to swing the blade from a vertical orientation suitable for making vertical cuts in a log and a horizontal orientation suitable for making horizontal cuts in the log; and
characterised in that the motor is at one side of the horizontal beam and the blade, when in the vertical orientation, is between an opposite side of horizontal beam and the motor.

28. A sawmill having a pair of end frames, a horizontal beam held elevated by the end frames, a saw comprising a motor and a blade, and a carriage arranged to move the saw back and forth along the beam;
a swing mechanism that incorporates a drive shaft connecting the blade to the motor, the swing mechanism arranged to swing the blade from a vertical orientation suitable for making vertical cuts in a log and a horizontal orientation suitable for making horizontal cuts in the log; and
characterised in that when the blade is in the vertical orientation at least part of the swing mechanism passes under the horizontal beam.

29. A sawmill having a pair of end frames, a horizontal beam held elevated by the end frames, a saw and a carriage arranged to move the saw back and forth along the beam;
the saw comprising a motor, a blade, a drive shaft connecting the motor and the blade, and a swing mechanism arranged to swing the blade from a vertical orientation suitable for making vertical cuts in a log and a horizontal orientation suitable for making horizontal cuts in the log; and
characterized in that when the blade is in the vertical orientation the swing mechanism is below an upper level of the horizontal beam and the blade is at an opposite side of the horizontal beam to the motor.

30. A sawmill having a pair of end frames, a horizontal beam held elevated by the end frames, a saw and a carriage arranged to move the saw back and forth along the beam;
the saw comprising a motor, a blade, a drive shaft connecting the motor and the blade, and a swing mechanism arranged to swing the blade from a vertical orientation suitable for making vertical cuts in a log and a horizontal orientation suitable for making horizontal cuts in the log; and
characterized in that the horizontal beam is mounted to an outside side of an upright post of each end frame such that when the blade is in the vertical orientation the blade is nearer to the upright post than the swing mechanism.
